(19) United States
(12) Patent Application Publication
(10) Pub. No.: US 2018/0374318 A1
(43) Pub. Date: Dec. 27, 2018

(54) METHOD TO DETECT THE POSSIBLE THREAT/ATTACK IN ATM BY EXTRACTING DEVIATIONS IN ATM DOOR/SHUTTER STATUS AND ALERTING CMS AND FIRST RESPONDERS

(71) Applicant: Honeywell International Inc., Morristown, NJ (US)

(72) Inventors: Ruban Sanjeevi, Bangalore (IN); Deepak Sundar Meganathan, Bangalore (IN)

(21) Appl. No.: 16/017,433

(22) Filed: Jun. 25, 2018

(30) Foreign Application Priority Data
Jun. 26, 2017 (IN) 201711022290

(51) Int. Cl. G07F 19/00; G08B 13/08

(52) U.S. Cl. CPC G07F 19/207; G08B 13/08; G07F 19/209

(57) ABSTRACT

Systems and methods for monitoring opening and closing of a shutter door of an automatic teller machine (ATM) are provided that include a door sensor detecting the opening and the closing of the shutter door, a central monitoring station (CMS) storing an opening and closing schedule for the ATM and remotely receiving information related to the opening and the closing of the shutter door from the door sensor, and raising an alert at the CMS when the information indicates that the shutter door is opened or closed outside of a scheduled time.

### FIELD OF THE INVENTION

The present invention relates to an automated teller machine (ATM) and, in particular, to a security system and a method for the ATM.

### BACKGROUND OF THE INVENTION

An ATM is widely used to provide various banking services, such as cash withdrawal, cash deposit, and check deposit, etc. in an efficient manner. The ATM is installed in a dedicated room having a shutter door placed after a glass door. The glass door provides a user of the ATM with an ability to conduct his transactions in a secured manner. The ATM also has additional security systems to reduce burglary and save evidence during such incidents, such as a means for image recording, a sensing means to determine when the shutter door opens/closes, a two way communication means, and the like. The shutter door placed after the glass door is used to close the ATM since the ATM is generally closed from 11 pm to 6 am. Also, the shutter door is closed when bank officials or cash loading agencies are loading cash inside the ATM. However, this approach has shortcomings because many robberies and thefts are carried out when the shutter door is closed. It is a general perception that when the shutter door is closed, cash is being loaded in the ATM by the bank officials or the cash loading agencies. In conventional art, the ATM is monitored by a central monitoring station (CMS) that can determine a status of the shutter door opening/closing. When the shutter door is opened during such a time frame, the security systems generate an alarm. However, if someone closes the shutter door between 6 am and 1 pm, no alarm is generated. Such a conventional system includes door sensors mounted on the shutter door determine the status of the shutter door (i.e. open/close), but there is no intelligent system to determine if the shutter door has been opened/closed at a specified time. Further, the conventional system cannot determine if the shutter door is opened/closed by authorized/unauthorized personnel. Thus, there is a need to provide a security system and a method that mitigates the above mentioned drawbacks.

### OBJECT OF THE INVENTION

It is an object of the present invention to provide an efficient security system and method to monitor opening and closing of an ATM shutter door.

### SUMMARY OF THE INVENTION

The present invention provides a security system for monitoring an ATM and a method for the same. According to an embodiment of the present invention, the security system for monitoring the ATM comprises a means for detecting opening and closing of a shutter door, an image recording means for recording images in the ATM, means for communicating an opening and closing schedule for the ATM to a CMS, and the CMS for remotely receiving information from said means for detecting opening and closing of the shutter door, wherein an alert is raised at the CMS if the shutter door is opened or closed beyond a scheduled time.

According to another embodiment of the present invention, a method of monitoring an ATM comprises the steps of: detecting opening and closing of a shutter door, receiving information from at least one door sensor at a CMS, receiving an opening and closing schedule for the ATM at the CMS from bank officials or cash loading agencies, determining if the shutter door is opened or closed according to a pre-decided schedule, and raising an alert at the CMS if the shutter door is opened or closed beyond a scheduled time.

### BRIEF DESCRIPTION OF THE DRAWINGS

FIG. 1 is a block diagram of a surveillance system according to an embodiment of the present invention;

FIG. 2 is a flowchart for a method of configuring a security system in an ATM according to an embodiment of the present invention; and

FIG. 3 is a flowchart for a method of detecting deviation in an ATM shutter door according to an embodiment of the present invention.

### DETAILED DESCRIPTION OF THE INVENTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiment.

The present invention provides a remote monitoring and validating solution for an ATM. Although the present invention has been explained in detail with respect to the ATM, the same is not limited only to ATMs and can be used in retail chains, jeweler shops, bank branches, financial institutions, and the like.

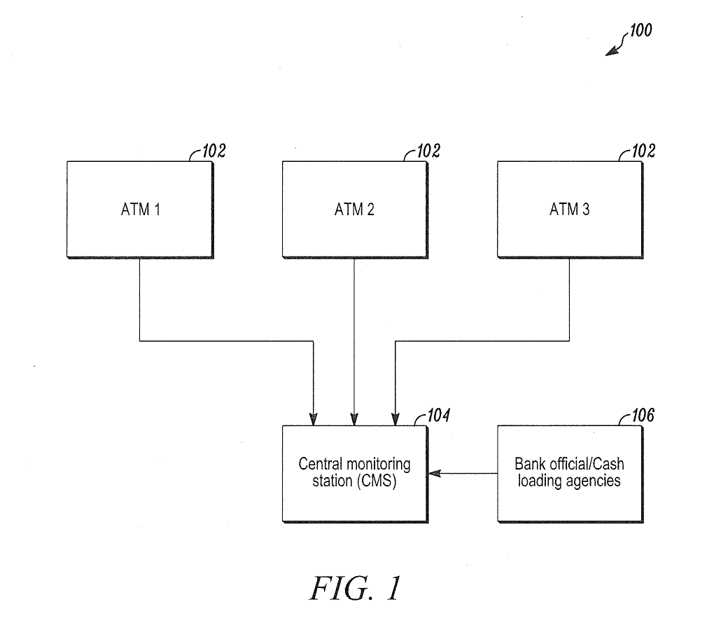

FIG. 1 is a block diagram of a surveillance system 100 according to an embodiment of the present invention. For ease of explanation, FIG. 1 discloses three ATMs 102 in communication with a CMS 104, but a plurality of ATMs 102 may be connected with the CMS 104. The embodiment of the surveillance system 100 shown in FIG. 1 is for illustration only, and other embodiments of the surveillance system 100 could be used without departing from the scope of the disclosure. The CMS 104 simultaneously monitors each and every one of the ATMs 102 connected to it through various monitoring means, such as a camera, sensors, and the like. The CMS 104 has its own database that stores scheduled open/close timings of all of the ATMs 102. Each of the ATMs 102 is configured with an expected open/close time. The expected open/close time is planned by bank officials or cash loading agencies 106, and the same is updated at the CMS 104. The bank officials or the cash loading agencies provide such an ATM wise cash loading schedule once a day or week or on an as needed basis to the CMS 104 for storage in the database of the CMS 104. Optionally, a cash loading event can happen automatically by sensing a cash loading event geolocation and an ATM location. Whenever a shutter door of a respective one of the ATMs 102 is opened/closed outside of a scheduled time, the surveillance system 100 sends an alert to the CMS 104 indicating a possible ATM incident or attack for review. Then, operators at the CMS 104 monitor that one of the ATMs 102 via a real time image recording means to confirm if there is an attack or not and suitably inform security agencies about the attack.

According to another embodiment of the present invention, additional security features may be incorporated in the ATMs 102. Generally, after the shutter door is closed, an ATM chest door/partition disarm event is expected so that cash is loaded in a respective one of the ATMs 102. However, during a burglary, this event does not take place as burglars do not have knowledge to disarm an ATM chest door/partition. Thus, when the ATM chest door/partition disarm event is not triggered after closing the shutter door, the surveillance system 100 sends an alert to the CMS 104 indicating the possible ATM incident or attack for review. Then, the operators at the CMS 104 monitor that one of the ATMs 102 via the real time image recording means to confirm if there is an attack or not and suitably inform the security agencies about the attack.

According to another embodiment of the present invention, at least two door sensors are provided in each of the ATMs 102. One of the door sensors detects when the shutter door is fully closed. Another of the door sensors detects when the shutter door is partly shut, i.e. below 50 percent of a door height. Thus, even when the shutter door is partly shut, an alert is sent to the CMS 104 to monitor a respective one of the ATMs 102 via the real time image recording means to confirm if there is an attack or not and suitably inform the security agencies about the attack.

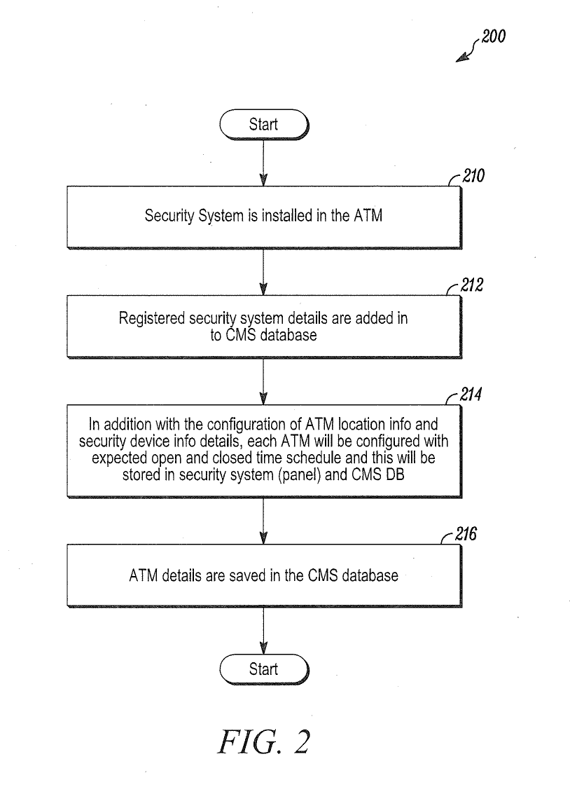

FIG. 2 is a flowchart for a method of configuring a security system in an ATM 102 according to an embodiment of the present invention. In the first step 210, the security system is installed at the ATM 102. The security system comprises an image capturing means, a shutter door open/close detecting means, such as a sensor, and a communicating means to communicate remotely with a CMS 104. Thereafter, registered security system details are added into a database of the CMS 104 at step 212. After this step, the ATM 102 is configured with a schedule containing its expected open and close times and ATM location information and security device information details at step 214. Such ATM details are saved in the database of the CMS 104 at step 216. Whenever cash is being loaded, a GPS location of the ATM 102 can be sent to the CMS 104. Similarly, the CMS 104 can be informed when armed guards are in the ATM 102 for legitimate purposes, such as maintaining the ATM 102 or loading the cash.

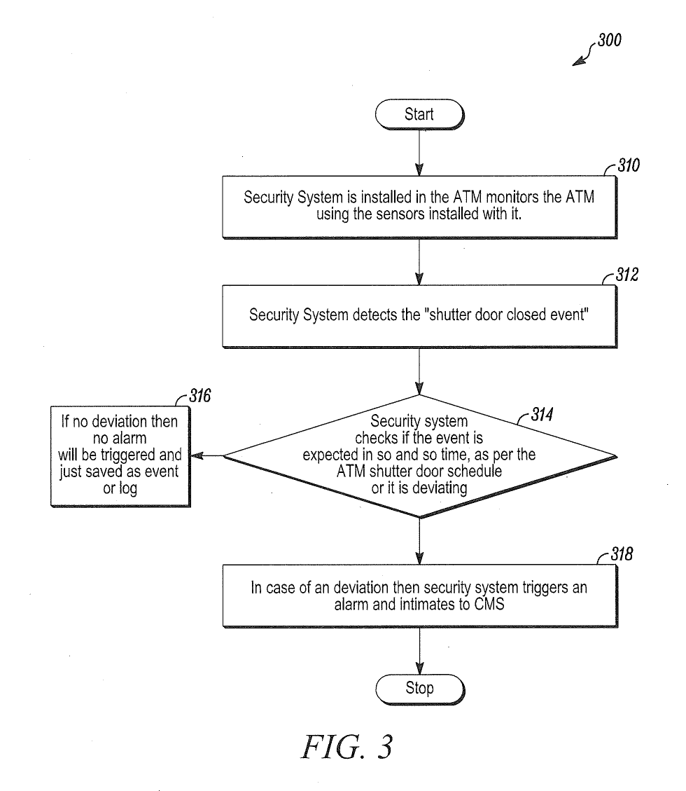

FIG. 3 is a flowchart for a method 300 of detecting deviation in an ATM shutter door according to an embodiment of the present invention. In the first step 310, a security system installed in an ATM 102 monitors the ATM 102 with one or more door sensors installed in the ATM 102. In the next step 312, the security system detects if the ATM shutter door is closed. Thereafter, the security system checks if the ATM shutter door is opened or closed according to a scheduled time at step 314. If the ATM shutter door is opened or closed outside of the scheduled time, then an alarm will be triggered, and an alert will be sent to a CMS 104 at step 318. When there is no deviation from the scheduled time, no alarm will be raised, the security system will keep monitoring the ATM 102, and such an event will be saved in a log at step 316.

Although a few modifications have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1-7. (canceled)

8. A security system comprising:
a door sensor for detecting opening and closing of a shutter door of an automated teller machine (ATM);
an image recorder for recording images proximate the ATM; and
a central monitoring station (CMS) for storing an opening and closing schedule for the ATM and for remotely receiving information related to the opening and the closing of the shutter door from the door sensor,
wherein an alert is raised at the CMS when the information indicates that the shutter door is opened or closed outside of a scheduled time.

9. The security system of claim 8 wherein the door sensor is installed at a bottom of the shutter door to determine when the shutter door is completely closed.

10. The security system of claim 8 wherein the door sensor is installed at a midway height of the shutter door to determine when the shutter door is partially closed.

11. The security system of claim 8 wherein the CMS simultaneously monitors a plurality of ATMs.

12. The security system of claim 8 wherein the CMS receives the opening and closing schedule for the ATM from bank officials or cash loading agencies.

13. The security system of claim 8 wherein the scheduled time is identified from the opening and closing schedule for the ATM.

14. The security system of claim 13 wherein the CMS raises the alert.

15. The security system of claim 8 wherein the scheduled time is identified responsive to an event detected at the ATM.

16. The security system of claim 15 wherein the ATM transmits the alert to the CMS.

17. The security system of claim 8 wherein the CMS retrieves the images from the image recorder responsive to the alert.

18. The security system of claim 8 wherein the information is based on the images from the image recorder.

19. A method comprising:
a door sensor detecting opening and closing of a shutter door of an automated teller machine (ATM);
a central monitoring station (CMS) storing an opening and closing schedule for the ATM and remotely receiving information related to the opening and the closing of the shutter door from the door sensor; and
raising an alert at the CMS when the information indicates that the shutter door is opened or closed outside of a scheduled time.

20. The method of claim 19 further comprising the CMS receiving the opening and closing schedule for the ATM from bank officials or cash loading agencies.

21. The method of claim 19 further comprising identifying the scheduled time from the opening and closing schedule for the ATM.

22. The method of claim 21 further comprising the CMS raising the alert.

23. The method of claim 19 further comprising identifying the scheduled time responsive to an event detected at the ATM.

24. The method of claim 23 further comprising the ATM transmitting the alert to the CMS.

25. The method of claim 18 further comprising the CMS retrieving the images from the image recorder responsive to the alert.

26. The method of claim 18 wherein the information is based on the images from the image recorder.
